(19) United States
(12) Patent Application Publication
(10) Pub. No.: US 2026/0251775 A1
(43) Pub. Date: Aug. 27, 2026

(54) WIND SPEED AND DIRECTION ESTIMATION

(71) Applicant: SIGNIFY HOLDING B.V., EINDHOVEN (NL)

(72) Inventor: PETER DEIXLER, ARLINGTON, MA (US)

(21) Appl. No.: 19/070,742

(22) Filed: Mar. 5, 2025

Related U.S. Application Data
(60) Provisional application No. 63/763,308, filed on Feb. 26, 2025.

(51) Int. Cl. G01S 13/58; G01S 13/86; G01S 13/931

(52) U.S. Cl. CPC G01S 13/588; G01S 13/589; G01S 13/86; G01S 13/931

(57) ABSTRACT

A method of estimating wind speed and wind direction includes selecting outdoor luminaires in a geographic region, where a first outdoor luminaire and a second outdoor luminaire are located a separation distance from each other on a side of a street. The method further includes recording, by the first outdoor luminaire, a sound and first reception time information that indicates at least a time during a reception of the sound by the first outdoor luminaire, where the sound is produced by a vehicle moving on the street in a driving direction. The method also includes recording, by the second outdoor luminaire, the sound and second reception time information. The method further includes estimating a component of a speed of wind in a direction that is parallel to the street based on at least the first reception time information, the second reception time information, and the separation distance.

### TECHNICAL FIELD

The present disclosure relates generally to wind speed and direction estimation, and more particularly to estimating wind speed and direction using outdoor lighting systems based on vehicle produced sound.

### BACKGROUND

Wind speed information can be useful for a number of reasons. For example, air pollution can be affected by wind speed, and wind speed information may be used to analyze, estimate, and/or predict air pollution, for example, for a city. As another example, the risk of damage to power lines from falling trees and/or branches can depend on wind speed. Wind speed is often gathered or forecasted on a regional basis or for large areas of a region, and thus, such wind speed information may be inaccurate for many parts of the region. For example, wind speed may be different along roadways that connect different cities, in different parts of a city, and even in different parts of smaller areas such as residential and/or business communities. To illustrate, differences in surface friction from vegetation, land, buildings, elevation, etc. can cause differences in wind speed in different parts of a region. In addition, wind gusts are often limited to a small areas. Because wind speed can be different in different parts of a region, hyper-local wind speed information for relatively small areas of a region can be valuable. However, installing weather stations or even anemometers in many parts of a region may not be practical. Thus, a solution that enables dynamically estimating the wind speed and direction in different areas may be desirable.

### SUMMARY

The present disclosure relates generally to wind speed and direction estimation, and more particularly to estimating wind speed and direction using outdoor lighting systems based on vehicle produced sound. In an example embodiment, a method of estimating wind speed and wind direction includes selecting outdoor luminaires in a geographic region, the outdoor luminaires each having a microphone unit, where a first outdoor luminaire of the outdoor luminaires and a second outdoor luminaire of the outdoor luminaires are located a separation distance from each other on a side of a street. The method further includes recording, by the first outdoor luminaire, a sound and first reception time information that indicates at least a time during a reception of the sound by the first outdoor luminaire, where the sound is produced by a vehicle moving on the street in a driving direction. The method also includes recording, by the second outdoor luminaire, the sound and second reception time information that indicates at least a time during a reception of the sound by the second luminaire. The method further includes estimating a component of a speed of wind in a direction that is parallel to the street based on at least the first reception time information, the second reception time information, and the separation distance.

These and other aspects, objects, features, and embodiments will be apparent from the following description and the appended claims.

### BRIEF DESCRIPTION OF THE FIGURES

Reference will now be made to the accompanying drawings, which are not necessarily drawn to scale, and wherein:

FIGS. 1 and 2 illustrate an outdoor luminaire system for estimating wind speed and direction according to an example embodiment;

FIG. 3 illustrates a block diagram of an outdoor luminaire corresponding to each luminaire of the outdoor luminaires of FIGS. 1 and 2 according to an example embodiment;

FIG. 4 illustrates a method of operations of the outdoor luminaire system of FIGS. 1 and 2 to estimate wind speed and direction according to an example embodiment; and

FIGS. 5A-5E illustrate a method of estimating wind speed and direction by the outdoor luminaire system of FIGS. 1 and 2 according to an example embodiment.

The drawings illustrate only example embodiments and are therefore not to be considered limiting in scope. The elements and features shown in the drawings are not necessarily to scale, emphasis instead being placed upon clearly illustrating the principles of the example embodiments. Additionally, certain dimensions or placements may be exaggerated to help visually convey such principles. In the drawings, the same reference numerals used in different figures may designate like or corresponding but not necessarily identical elements.

### DETAILED DESCRIPTION OF THE EXAMPLE EMBODIMENTS

In the following paragraphs, example embodiments will be described in further detail with reference to the figures. In the description, well known components, methods, and/or processing techniques are omitted or briefly described. Furthermore, reference to various feature(s) of the embodiments is not to suggest that all embodiments must include the referenced feature(s).

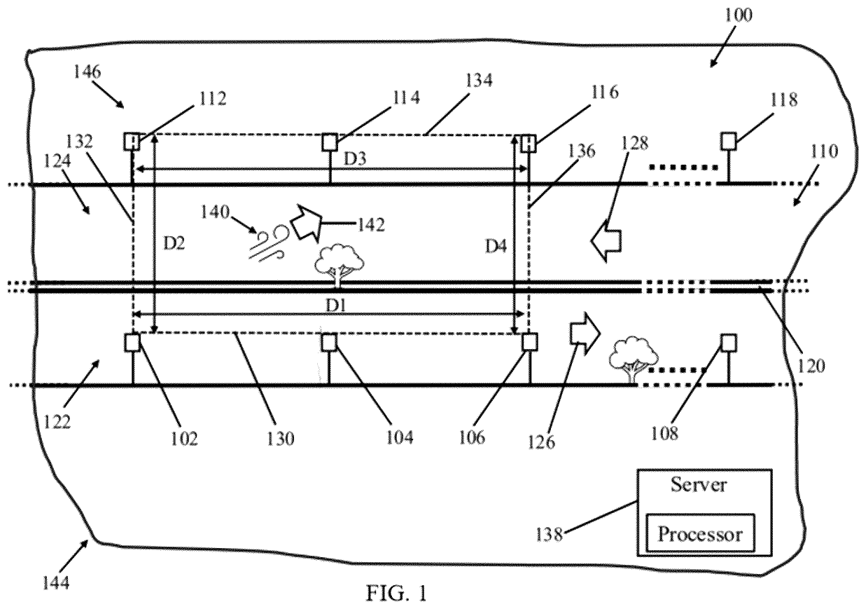

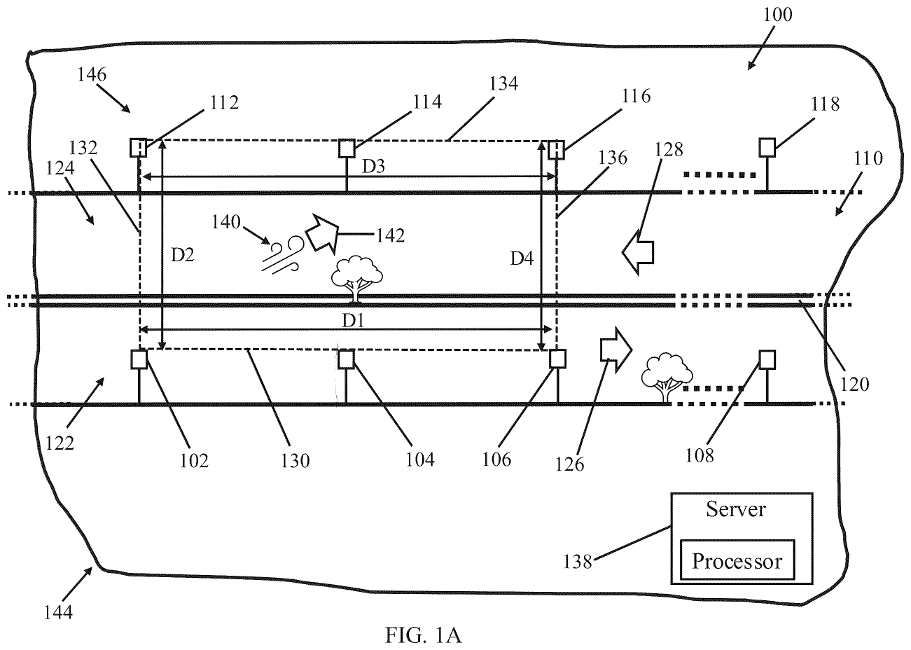

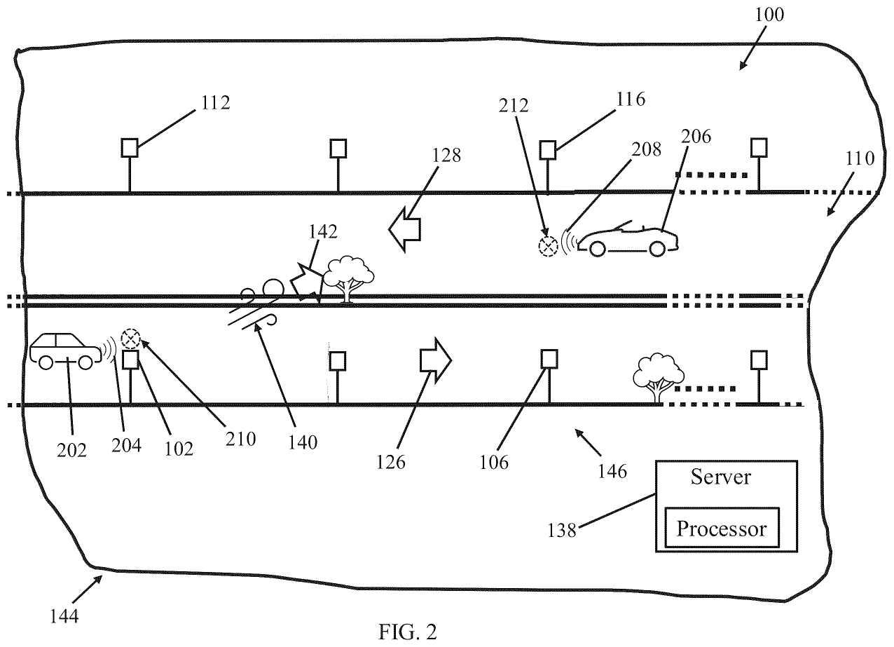

FIGS. 1 and 2 illustrate an outdoor luminaire system 100 for estimating wind speed and direction according to an example embodiment. In general, the outdoor luminaire system 100 may estimate wind speed and direction based on a sound captured (i.e., received) by microphone devices of two or more outdoor luminaires of the system 100 and the reception times of the sound by the two or more outdoor luminaires. In some example embodiments, the system 100 includes outdoor luminaires 102, 104, 106, 108, 112, 114, 116, and 118 as well as other outdoor luminaires. For example, the outdoor luminaires 102-108, 112-118 may be located in a geographic region 144, that may be a city, an area within a city, a county, a multi-city region, an area between cities (e.g., a rural area), etc. The outdoor luminaires 102-108 and 112-118 may be streetlight luminaires. The outdoor luminaires 102-108 and 112-118 may be positioned directly above the street 110. For example, the outdoor luminaires 102-108 and 112-118 may each be attached to a branch of a respective pole, where the branch extends toward the street 110 such that the outdoor luminaires 102-108 and 112-118 are vertically above the street 110.

In some example embodiments, the outdoor luminaires 102-108 may be on one side of a street 110, and the outdoor luminaires 112-118 may be on an opposite side of the street 110 from the outdoor luminaires 102-108. For example, the outdoor luminaire 112 may be directly across the street 110 from the outdoor luminaire 102, and the outdoor luminaire 108 may be directly across the street 110 from the outdoor luminaire 118. To illustrate, a virtual line 130 that extends between the outdoor luminaire 102 and the outdoor luminaire 106 and a virtual line 132 that extends between the outdoor luminaire 102 and the outdoor luminaire 112 may form a 90-degree angle (i.e., a right angle) therebetween or approximately 90 degrees (e.g., 85 to 95 degrees due to marginal variations in installation locations of one or more of the outdoor luminaires 102, 106, 112). In general, the virtual line 130 that extends between the outdoor luminaire 102 and the outdoor luminaire 106 and a virtual line 134 that extends between the outdoor luminaire 112 and the outdoor luminaire 116 may be parallel or substantially parallel to each other and to the street 110. The virtual lines 130, 132, 134, 136 are shown as dotted lines for clarity of illustration.

In some example embodiments, the street 110 may include lanes 122, 124 for automobile traffic flow in two opposite moving directions as shown by arrows 126 and 128. For example, vehicles may move in the lane 122 in the moving direction shown by the arow 126 and in the lane 124 in the moving direction shown by the arow 128. The street 110 may include a lane separator section 120 (e.g., a double-line or a median) separating the lane 122 from the lane 124. In some alternative embodiments, the street 110 may have one or more lanes than shown in one or both directions shown by the arrows 126, 128 without departing from the scope of this disclosure. In some alternative embodiments, the outdoor luminaires 102-108, 112-118 may be located in the lane separator section 120 without departing from the scope of this disclosure. For example, the outdoor luminaires 102 and 112 may be attached to the same pole with branching extending in opposite directions, and the outdoor luminaires 106 and 116 may be attached to the same pole with branching extending in opposite directions.

In some example embodiments, the locations of the outdoor luminaires 102-108, 112-118 are known, for example, from installation data and/or from global positioning system (GPS) data obtained from a GPS unit of each one of the outdoor luminaires 102-108, 112-118. For example, the system 100 may include a server 138 that can access information indicating the locations of the outdoor luminaires 102-108, 112-118. The server 138 may be a local server or a remote server such as a cloud server. The outdoor luminaire 102 and the outdoor luminaire 106 may be located a separation distance D1 apart from each other on the same side of the street 110. The outdoor luminaire 102 and the outdoor luminaire 112 may be located a separation distance D2 apart from each other. The outdoor luminaire 112 and the outdoor luminaire 116 may be located a separation distance D3 apart from each other on the same side of the street 110. The outdoor luminaire 116 and the outdoor luminaire 106 may be located a separation distance D4 apart from each other and across the street 110 from each other. In general, the separation distance D1 may substantially equal the separation distance D3, and the separation distance D2 may substantially equal the separation distance D4, where differences between the separation distances D1 and D3 and between the separation distances D2 and D4 may be, for example, due to installation related variations.

In some example embodiments, two or more outdoor luminaires from among the outdoor luminaires of the system 100 may be selected to estimate wind speed and direction in a particular area within the geographic region 144. To illustrate, wind speed and direction in an area within the geographic region 144 may be of a particular interest for a number of reasons. For example, wind speed and direction information may be relevant for safe construction or other outdoor work in an area, and general wind condition information available for the entire geographic region 144 may not be adequate. As another example, wind speed and direction information for an area within the geographic region 144 may be relevant to monitor air pollution that can be influenced by wind conditions.

In some example embodiments, the system 100 may estimate wind speed and direction based on sounds produced by vehicles moving on streets in the different areas of the geographic region 144. The sounds produced by vehicles may be engine sounds, sounds caused by tires rolling on streets, car horn sounds, etc. that are captured/received by microphone units of a subset of outdoor luminaires selected from among outdoor luminaires of the system 100 including the outdoor luminaires 102-108, 112-118. Subsets of outdoor luminaires selected from among the outdoor luminaires of the system 100 may be used to estimate the speed and direction of wind in different areas within the geographic region 144. For example, the server 138 of the system 100 may estimate wind speed and direction based on a sound or sounds produced by one or more vehicles and received and recorded by the selected outdoor luminaires of the system 100 along with time of reception information (also referred to herein as reception time information) as explained below in more detail.

To be clear, each outdoor luminaire of the system 100 may record a sound along with time of reception information (e.g., one or more timestamps) if the level of the sound as received by the particular outdoor luminaire equals or exceeds a threshold sound level. The threshold sound level may be set such that a typical sound generated by a vehicle (e.g., a sedan or a three-plus axle vehicle) that is within a threshold distance from the particular outdoor luminaire is likely to equal or exceed the threshold sound level. The threshold distance may equal, for example, once, twice, or three times (or another integer or non-integer multiplier) the typical separation distance between adjacent outdoor luminaires of the system 100. In some cases, the threshold sound level may be set such that the outdoor luminaires of the system 100 record sounds generated by larger vehicles such as vehicles with three-plus axles and not smaller vehicles. Alternatively or in addition, the server 138 may process the sounds recorded by outdoor luminaires of the system to determine whether the sounds are generated by relatively large vehicles such as three or more axle vehicles.

In some example embodiments, a subset of outdoor luminaires may be selected from among the outdoor luminaires of the system 100 to estimate wind speed and direction in an area of interest where some of the outdoor luminaires 102-108, 112-118 are located. For example, the outdoor luminaires 102, 106 may be selected to estimate the speed and direction of the wind 140 in a wind condition estimation area 146 that is in the geographic region 144. As another example, the outdoor luminaires 102, 106, 112 may be selected to estimate the speed and direction of the wind 140 in the wind condition estimation area 146. The wind 140 may have a heading direction shown by an arrow 142 or may alternatively have another heading direction that may be parallel to the street 110, perpendicular to the street 110, or at another angle relative to the street 110. To be clear, the area of interest for estimating wind speed and direction may be a larger area that includes the wind condition estimation area 146 and that has more outdoor luminaires than shown in FIGS. 1 and 2.

In some example embodiments, when wind direction is reliably known to be parallel or perpendicular to the street 110 and thus, to a virtual line connecting two outdoor luminaires in the wind condition estimation area 146, the particular two outdoor luminaires may be selected to estimate wind speed in the wind condition estimation area 146. For example, the outdoor luminaires 102, 106, the outdoor luminaires 102, 104, or the outdoor luminaires 112, 116 may be selected to estimate the speed of the wind 140 in the wind condition estimation area 146 when the direction of the wind 140 is known to be parallel to the street 110. As another example, the outdoor luminaires 102, 112 or the outdoor luminaires 106, 116 may be selected to estimate the speed of the wind 140 in the wind condition estimation area 146 when the direction of the wind 140 is known to be perpendicular to the street 110.

In some example embodiments, a first pair of outdoor luminaires in the wind condition estimation area 146 may be selected to estimate a component of the speed of the wind 140 in a direction parallel to the street 110 and to the virtual line connecting the two outdoor luminaires of the first pair. A second pair of outdoor luminaires having a common outdoor luminaire with the first pair of outdoor luminaires may be selected to estimate a component of the speed of the wind 140 in a direction perpendicular to the street 110 and to the virtual line connecting the two outdoor luminaires of the first pair and parallel to the virtual line connecting the two outdoor luminaires of the second pair.

To illustrate, the outdoor luminaires 102, 106, the outdoor luminaires 102, 104, or the outdoor luminaires 112, 116, or another pair of outdoor luminaires on the same side of the street 110 in the wind condition estimation area 146 may be selected to estimate the component of the speed of the wind 140 in a direction parallel to the street 110 even when the direction of the wind 140 is not parallel to the street 110. The outdoor luminaires 102, 112, the outdoor luminaires 106, 116, or another pair of outdoor luminaires that are directly across the street 110 from each other may be selected to estimate the component of the speed of the wind 140 in a direction perpendicular to the street 110 even when the direction of the wind 140 is not perpendicular to the street 110. The overall speed and direction of the wind 140 may be determined as a vector sum of the component of the speed of the wind 140 in the direction parallel to the street 110 and the component of the speed of the wind 140 in the direction perpendicular to the street 110.

In some example embodiments, the speed and direction of the wind 140 may be estimated based on a sound, such as sounds 204, 208, produced by a moving vehicle, such as a vehicle 202 and a vehicle 206 moving on the street 110. For example, the sound 204 produced by the vehicle 202 may be generated by the engine of the vehicle 202, the tires of the vehicle 202, the vehicle horn (i.e., honk sound), etc. and the sound 208 produced by the vehicle 206 may be generated by the engine of the vehicle 206, the tires of the vehicle 206, the vehicle horn (i.e., honk sound), etc. The sounds 204, 208 may each be received by microphone devices of two or more outdoor luminaires of the system 100 located in the wind condition estimation area 146 and may each be used separately to estimate the speed and direction of the wind 140. To illustrate, the difference in corresponding times of reception of a sound, such as each one of the sounds 204, 208, by two or more outdoor luminaires, such as the outdoor luminaires 102, 106, 112, 116 may be used to estimate the speed and direction of the wind 140.

In general, to estimate the speed and direction of wind, two or more outdoor luminaires of the system 100 may be selected based on locations of the outdoor luminaires with respect to an area of interest such as the wind condition estimation area 146, traffic level in the vicinity of the outdoor luminaires, noise level in the vicinity of the outdoor luminaires, general current or forecasted weather information, etc. To illustrate, the outdoor luminaires 102, 106 may be selected to estimate the speed and direction of the wind 140 in the wind condition estimation area 146 at least because of the locations of the outdoor luminaires 102, 106 in the area of interest.

In some example embodiments, in addition to being located in the wind condition estimation area 146, two outdoor luminaires of the system 100 may be selected to estimate the speed of the wind 140 in a particular direction, for example, when the direction of the wind 140 is known or expected to be parallel to the virtual line connecting the two outdoor luminaires. For example, the outdoor luminaires 102, 106 may be selected based on current or forecasted wind conditions indicating that the wind 140 is coming from or heading in a direction that is aligned with/parallel to the street 110 and thus to the virtual line 130 connecting the outdoor luminaires 102, 106.

As another example, the outdoor luminaires 102, 112 may be selected based on current or forecasted wind conditions indicating that the wind 140 is coming from or heading in a direction that is perpendicular to the street 110 and thus parallel to the virtual line 132 connecting the outdoor luminaires 102, 112. To be clear, two outdoor luminaires of the system 100 that are located in the wind condition estimation area 146 may be selected to estimate a component of the speed of the wind 140 in a particular direction parallel to the virtual line connecting the two outdoor luminaires regardless of the heading direction of the wind 140.

In some example embodiments, in addition to being located in the wind condition estimation area 146, two outdoor luminaires of the system 100 may be selected to estimate the speed of the wind 140 based on low traffic and/or noise levels in the vicinity of the outdoor luminaires. For example, the outdoor luminaires 102, 106, 112 may be selected because of low traffic and/or noise levels in the vicinity of the outdoor luminaires 102, 106, 112 to minimize interference with the sound 204 that is used to estimate the speed and direction of the wind 140.

To illustrate, low traffic level may facilitate finding moments where a single vehicle (e.g., the vehicle 202) is in the vicinity of the outdoor luminaires 102, 106, 112 such that the sound generated by the vehicle can be received by the outdoor luminaires 102, 106, 112 with minimal or no interference from sounds generated by other vehicles. A low noise level may also facilitate finding moments where noise interference with the sound (e.g., the sound 204) generated by a vehicle (e.g., the vehicle 202) is minimal. As such, traffic level and noise level in the vicinities of outdoor luminaires of the system 100 may be monitored to identify particular outdoor luminaires with adequately low nearby traffic and noise levels. For example, radar data, vibration data, and/or sounds captured by the outdoor luminaires of the system 100 may be used to identify particular outdoor luminaires that have adequately low nearby traffic level and/or noise level.

In some example embodiments, in addition to location, traffic level, and/or noise level, two or more outdoor luminaires of the system 100 may be selected based on the level of obstruction between the outdoor luminaires. For example, the outdoor luminaires 102, 104 or the outdoor luminaires 102, 106 may be selected because of the absence of obstruction such as, for example, from trees, etc., therebetween. As another example, when three outdoor luminaires are selected, the outdoor luminaires 102, 106, 112 may be selected because of the absence of obstruction between the outdoor luminaires 102, 106 and between the outdoor luminaires 102, 112. As another example, when four outdoor luminaires are selected, the outdoor luminaires 102, 106, 112, 116 may be selected because of the absence of obstruction between the outdoor luminaires 102, 106, between the outdoor luminaires 102, 112, and between the outdoor luminaires 112, 116. In contrast, the outdoor luminaire 104, 114 may not be selected as a pair or along with another outdoor luminaire because of possible sound obstruction by a tree located between the outdoor luminaires 104, 114.

In some example embodiments, multiple subsets of outdoor luminaires of the system 100 may include outdoor luminaires can be used to estimate the speed and direction of the wind 140 in the wind condition estimation area 146. For example, the outdoor luminaires 102, 106, 112 as well as the outdoor luminaires 116, 112, 106 may be usable to estimate the speed and direction of the wind 140. In such cases, the speed and direction of the wind 140 may be estimated using both subsets of outdoor luminaires, and the estimates made based on the two subsets of outdoor luminaires can be compared against each other to verify/confirm the accuracy of the estimates. As another example, although the outdoor luminaires 102, 106 as well as the outdoor luminaires 102, 104 and the outdoor luminaires 104, 106 may be used to estimate the speed of the wind 140 or a component of the speed of the wind 140, the outdoor luminaires 102, 106 may be selected, for example, because the separation distance D1 (e.g., 60 meters or 100 meters) between the outdoor luminaires 102, 106 is expected to result in a more accurate estimate than a separation distance (e.g., 25 meters or 50 meters) between the outdoor luminaires 102, 104.

In some example embodiments, if multiple vehicles are simultaneously moving in the vicinity of one or more outdoor luminaires such that sounds generated by the multiple vehicles are received by the one or more outdoor luminaires, the received sounds may not be used to estimate wind speed and direction. For example, if two or more vehicles, including the vehicle 202, are moving in the lane 122 of the street 110 in the direction shown by the arrow 126 such that sounds generated by the vehicles are received by the outdoor luminaire 102, the sounds, including the sound 204, received by the outdoor luminaire 102 and, for example, by the outdoor luminaire 106 may not be used to estimate the speed and direction of the wind 140 so as to minimize inaccuracies in wind speed and direction estimate. The presence of multiple vehicles in the vicinity of an outdoor luminaire may be detected based on radar detection, vibration sensing, RF sensing by one or more outdoor luminaires of the system 100.

As another example, the presence of multiple vehicles in the vicinity of an outdoor luminaire may be determined by analyzing sound data of sounds captured/received by an outdoor luminaire. For example, the server 138 may determine whether multiple vehicles are in the vicinity of an outdoor luminaire based on radar detection data, vibration sensing data, RF sensing data, and/or sound data from the particular outdoor luminaire. Indeed, particular outdoor luminaires (e.g., the outdoor luminaires 102, 106, 112) may be selected for the purpose of estimating wind speed and direction using a sound received by the outdoor luminaires based on no more than one vehicle being detected in the detection range of each one of the outdoor luminaires.

As described above, in some example embodiments, the speed and direction of the wind 140 may be estimated based on a sound, such as sounds 204, 208, produced by a moving vehicle, such as the vehicle 202 and the vehicle 206. To illustrate, the sounds 204, 208 may each be received by two or more outdoor luminaires of the system 100 located in the wind condition estimation area 146 and may be used to estimate the speed and direction of the wind 140. To illustrate, the difference in corresponding times of reception of the sound 204 and/or the sound 208 by two or more outdoor luminaires, such as the outdoor luminaires 102, 106, 112, 116 may be used to estimate the speed and direction of the wind 140.

For example, the sound 204 may be received by the outdoor luminaires 102, 106, 112 at corresponding times that depend on the location of the vehicle 202 relative to the outdoor luminaires 102, 106, 112. When the vehicle 202 is at a particular location as the vehicle moves on the street 100 in the moving direction shown by the arrow 126, the corresponding times of reception of the sound 204 by the outdoor luminaires 102, 106, 112 may be different because of the difference in distance between the outdoor luminaires 102, 106, 112 relative to the particular location of the vehicle 202. In general, corresponding times of reception of a sound (e.g., the sound 204) by two or more outdoor luminaires are in reference to the sound as generated at a particular instance in time that may correspond to a particular location of a vehicle (e.g., the vehicle 202).

In some example embodiments, to estimate the speed and direction of the wind 140 based on the difference in corresponding times of reception of a sound by two or more outdoor luminaires, the corresponding times of reception need to first be identified. For example, to identify corresponding times of reception of a sound by two or more other outdoor luminaires, a time of reception of the sound by one of the outdoor luminaires may be used as a reference time of reception of the sound, where the reference time of reception of the sound may correspond to the location of the vehicle that generates the sound.

To illustrate with respect to the outdoor luminaires 102, 106, the time of reception of the sound 204 by the outdoor luminaire 102 when the vehicle 202 is generally at the outdoor luminaire 102, such as in front of the outdoor luminaire 102 (e.g., at a location shown by a virtual marker 210), may be used as a reference time of reception of the sound 204. The outdoor luminaire 102 and/or the server 138 may determine when the vehicle 202 is in front of the outdoor luminaire 102, such as at the location shown by the virtual marker 210, based on radar detection, vibration sensing, radiofrequency (RF) sensing, and/or by processing (e.g., based on doppler shift) the sound 204 and record the corresponding time of reception of the sound 204 by the outdoor luminaire 102.

The sound 204 as received by the outdoor luminaire 102 at the reference time of reception (or in a time interval before and/or after the reference time of reception) may be compared to the sound 204 as received by the outdoor luminaire 106 to determine a time of reception of the sound 204 by the outdoor luminaire 106 that corresponds to the reference time of reception of the sound 204 by the outdoor luminaire 102. For example, one or more characteristics (e.g., frequency, normalized amplitude, etc.) of the sound 204 as received by the outdoor luminaire 102 at the reference time of reception (or in a time interval before and/or after the reference time of reception) may be compared to the same characteristics of the sound 204 as received by the outdoor luminaire 106 to identify corresponding times of reception of the sound 204 by the outdoor luminaires 102, 106.

In some example embodiments, the comparison of the sound 204 as received by the outdoor luminaires 102, 106 can be performed based on sound data and associated reception time information (also referred to herein as time of reception information) stored by each one of the outdoor luminaires 102, 106 during the reception of the sound 204 by the outdoor luminaires 102, 106. To illustrate, the sound 204 may be received and recorded (i.e., stored) by each one of the outdoor luminaires 102, 106 as sound data along with respective reception time information from the respective GPS unit of the outdoor luminaires 102, 106. After the corresponding time of reception of the sound 204 at the outdoor luminaire 106 is identified, the difference in the corresponding times of reception of the sound 204 by the outdoor luminaires 102, 106 may be determined. For example, the difference in the corresponding times of reception of the sound 204 by the outdoor luminaires 102, 106 may be determined be subtracting the reference time of reception by the outdoor luminaire 102 (e.g., the earlier time of reception) from the corresponding time of reception by the outdoor luminaire 106.

In some alternative embodiments, the reference time of reception of the sound 204 by the outdoor luminaire 102 may correspond to a location of the vehicle 202 other than at the front of the outdoor luminaire 102. For example, the reference time of reception of the sound 204 by the outdoor luminaire 102 may correspond to a location of the vehicle 202 before the vehicle 202 reaches the outdoor luminaire 102. As described above, each outdoor luminaire of the system 100 may record a sound along with time of reception information (e.g., one or more timestamps) if the level of the sound as received by the particular outdoor luminaire equals or exceeds a threshold sound level. The threshold sound level may be set such that a typical sound generated by a vehicle (e.g., a sedan or a three-plus axle vehicle) that is within a threshold distance from the particular outdoor luminaire is likely to equal or exceed the threshold sound level. In some alternative embodiments, the outdoor luminaires of the system 100 may continuously record sound along with reception time information.

In some example embodiments, the difference in the corresponding times of reception of the sound 204 by the outdoor luminaires 102, 112 may be determined in the manner described with respect to the outdoor luminaires 102, 106. For example, the corresponding times of reception of the sound 204 by the outdoor luminaires 102, 112 may be identified, and the reference time of reception (e.g., the time of reception of the sound 204 by the outdoor luminaire 102) may be subtracted from the corresponding time of reception of the sound 204 by the outdoor luminaire 112 to determine the difference in the corresponding times of reception of the sound 204 by the outdoor luminaires 102, 112.

In some example embodiments, the sound 208 generated by the vehicle 206 may be received by the outdoor luminaires 106, 112, 116, and the difference in the corresponding times of reception of the sound 208 by the outdoor luminaires 112, 116 and the difference in the corresponding times of reception of the sound 208 by the outdoor luminaires 106, 116 may be determined in the manner described above with respect to the outdoor luminaires 102, 106, 112. Because the vehicle 206 generating the sound 208 travels in the moving direction indicated by the arrow 128 passes by the outdoor luminaire 116 before passing by the outdoor luminaire 112, the time of reception of the sound 208 by the outdoor luminaire 116 when the vehicle 206 is generally at the outdoor luminaire 116, such as in front of the outdoor luminaire 116 (e.g., at a location shown by a virtual marker 212), may be used as a reference time of reception in the manner described above with respect to the sound 204 and the outdoor luminaire 102.

In some alternative embodiments, the reference time of reception of the sound 208 by the outdoor luminaire 116 may correspond to a location of the vehicle 206 other than at the front of the outdoor luminaire 116. For example, the reference time of reception of the sound 208 by the outdoor luminaire 116 may correspond to a location of the vehicle 206 before the vehicle 206 reaches the outdoor luminaire 116.

In some example embodiments, the difference in the corresponding times of reception of the sound 208 by the outdoor luminaires 106, 116 may be determined in the manner described with respect to the outdoor luminaires 112, 116. For example, the corresponding times of reception of the sound 208 by the outdoor luminaires 106, 116 may be identified using the time of reception of the sound 208 by the outdoor luminaire 116 as the reference time of reception of the sound 208. The difference in the corresponding times of reception of the sound 208 by the outdoor luminaires 106, 116 may be determined by subtracting the reference time of reception of the sound 208 from the corresponding time of reception of the sound 208 by the outdoor luminaire 106.

In some example embodiments, the difference in corresponding times of reception of the sound 204 by the outdoor luminaires 102, 106 determined as described above can be used to estimate the component of the speed of the wind 140 in a direction that is parallel to the street 110 and the virtual line 130. The difference in corresponding times of reception of the sound 204 by the outdoor luminaires 102, 112 can be used to estimate the component of the speed of the wind 140 in a direction that is perpendicular to the street 110 and parallel to the virtual line 132.

To be clear, when the heading direction of the wind 140 is parallel to the street 110 and thus to the virtual line 130, the component of the speed of the wind 140 in a direction parallel to the street 110 and to the virtual line 130 may be the same as the speed of the wind 140. When the heading direction of the wind 140 is perpendicular to the street 110 and parallel to the virtual line 132, the component of the speed of the wind 140 perpendicular to the street 110 and parallel to the virtual line 132 may be the same as the speed of the wind 140.

In some example embodiments, the difference in corresponding times of reception of the sound 208 by the outdoor luminaires 112, 116 determined as described above can be used to estimate the component of the speed of the wind 140 in a direction that is parallel to the street 110 and the virtual line 134 (or equivalently, parallel to the virtual line 130). The difference in corresponding times of reception of the sound 208 by the outdoor luminaires 106, 116 can be used to estimate the component of the speed of the wind 140 in a direction that is perpendicular to the street 110 and parallel to the virtual line 136 (or equivalently, parallel to the virtual line 132). The virtual lines 130, 132, 134, 136 may form a rectangular shape, where the virtual lines 130, 134 are parallel to each other and where the virtual lines 132, 136 are parallel to each other.

To be clear, when the heading direction of the wind 140 is parallel to the street 110 and thus to the virtual lines 130, 134, the component of the speed of the wind 140 in a direction parallel to the street 110 and to the virtual lines 130, 134 may be the same as the speed of the wind 140. When the heading direction of the wind 140 is perpendicular to the street 110 and parallel to the virtual lines 132, 136, the component of the speed of the wind 140 perpendicular to the street 110 and parallel to the virtual lines 132, 136 may be the same as the speed of the wind 140. The speed and direction of the wind 140 estimated based on the sound 208 may be compared against the speed and direction of the wind 140 estimated based on the sound 204 to confirm/verify the reliability of the estimates.

In some cases, to minimize mismatches between estimates made based on the sounds 204 and 208 due to momentary wind speed changes, such as due to wind gusts, the wind speed and direction estimates may be made based on reference times of receptions of the sounds 204 and 208 by the outdoor luminaires 102 and 116, respectfully, when the vehicles 202 and 206 are concurrently approximately (e.g., within 5 seconds of each other) in front of the outdoor luminaires 102 and 116, respectfully.

In some example embodiments, Equation (1) below can be used to estimate the speed and direction of wind based on a sound received by two of more outdoor luminaires. For example, Equation (1) may be used to estimate a first component of the speed of the wind 140 in a direction parallel to the street 110 based on a sound (e.g., the sound 204) received by two outdoor luminaires (e.g., the outdoor luminaires 102, 106). Separately, Equation (1) may be used to estimate a second component of the speed of the wind 140 in a direction perpendicular to the street 110 based on the same sound (e.g., the sound 204) received by two outdoor luminaires (e.g., the outdoor luminaires 102, 112). A vector addition of the two components can be performed to estimate the speed and direction of the wind 140 as can be readily understood by those of ordinary skill in the art with the benefit of this disclosure. If the direction of the wind 140 is parallel or perpendicular to the street 110, the first component or the second component of the speed of the wind 140 may be the same as the speed of the wind 140. In general, the server 138 may receive sound data and time reception information from the outdoor luminaires of the system 100 and may execute Equation (1), for example, by executing a software code.

$$S w = ( \frac{Distance}{Time Delta} ) - S s \qquad Eq ( 1 )$$

In Equation (1), Sw may be a component of the speed of the wind in a direction parallel to the virtual line connecting the two outdoor luminaires that received a sound such as the sound 204 or the sound 208. Alternatively, Sw may be the speed of the wind if the heading direction of the wind is parallel to the virtual line connecting the two outdoor luminaires. ‘Distance’ in Equation (1) is the separation distance between two outdoor luminaires that received the sound. For example, ‘Distance’ may be the separation distance D1 between the outdoor luminaires 102, 106. Time Delta in Equation (1) is the difference in corresponding times of reception of the sound (e.g., the sound 204 or the sound 208) by the two outdoor luminaires as described above. For example, the reference time of reception (i.e., the earlier time of reception of the sound) at one outdoor luminaire (e.g., the outdoor luminaires 102) may be subtracted from the time of reception of the sound at the second outdoor luminaire (e.g., the outdoor luminaire 106). Ss in Equation (1) is the speed of sound in air, which is 343 meters per second (m/s) at 20° C. (i.e., 68° F.) temperature. A different value may be used for Ss based on temperature, humidity, and other relevant conditions of the air in the area, such as the wind condition estimation area 146. For example, the speed of sound in relatively dry air may be 340 m/s and may be 346 m/s in relatively moist air.

In some example embodiments, the polarity of the value of Sw may indicate the direction of the component of the speed of the wind or the direction of the wind. For example, if Equation (1) produces a positive value for Sw, the component of the speed of the wind parallel to the virtual line connecting the two outdoor luminaires (e.g., outdoor luminaires 102, 106) may be directed toward the second outdoor luminaire (e.g., outdoor luminaire 106). If Sw has negative value, the component of the speed of the wind parallel to the virtual line connecting the two outdoor luminaires (e.g., outdoor luminaires 102, 106) may be directed toward the first outdoor luminaire (e.g., outdoor luminaire 102). To be clear, the polarity of the value of Sw may depend on whether the time of reception by the first outdoor luminaire or by the second outdoor luminaire is used as the reference time of reception for calculating the Time Delta.

As described above, by using Equation (1) to estimate components of the speed of the wind 140 in parallel and perpendicular directions to the street 110 and by performing a vector addition of the estimated components, the speed and direction of the wind 140 may be estimated. If the direction of the wind 140 is parallel or perpendicular to the street 110, one of the two components may be equivalent to the speed of the wind 140 as the other component would be zero. In addition, the components of the speed of the wind 140 may be estimated using two or subsets of outdoor luminaires in the wind condition estimation area 146, comparisons of corresponding estimated components may be performed to confirm the reliability of the estimates. In general, by using sounds generated by vehicles and received by outdoor luminaires of the system 100, wind speed and direction may be estimated for many areas of the geographic region 144, thereby providing more granular wind condition information than otherwise available.

In some alternative embodiments, the outdoor luminaire system 100 may include multiple servers without departing from the scope of this disclosure. In some alternative embodiments, some outdoor luminaire of the system 100 may be located in the lane separator section 120 (e.g., a median) without departing from the scope of this disclosure. In some alternative embodiments, adjacent outdoor luminaires, such as the outdoor luminaires 102, 104, may be used in estimating wind speed and direction without departing from the scope of this disclosure.

In some alternative embodiments, outdoor luminaires on the same side of a street and that have more than one other outdoor luminaire therebetween may be used in estimating wind speed and direction without departing from the scope of this disclosure. In FIGS. 1 and 2, the appearance of the outdoor luminaires is not intended to indicate a particular type of street luminaire, and the outdoor luminaires may be different types of outdoor luminaires.

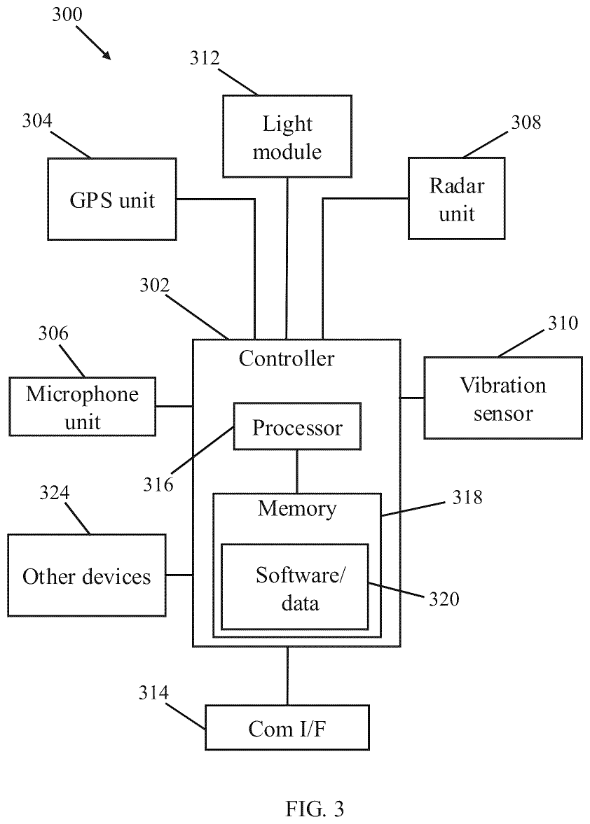

FIG. 3 illustrates a block diagram of an outdoor luminaire 300 corresponding to each luminaire of the outdoor luminaire system 100 of FIGS. 1 and 2 according to an example embodiment. For example, each one of the outdoor luminaires of the system 100 of FIGS. 1 and 2, including the outdoor luminaires 102-108, 112-118, may be an instance of the outdoor luminaire 300. Referring to FIGS. 1, 2, and 3, in some example embodiments, the outdoor luminaire 300 includes a controller 302 that may include a processor 316 (e.g., a microprocessor) and a memory device 318 (e.g., a nonvolatile memory device such as a flash memory device). The memory device 318 may contain software code and data 320 that may include one or more AI models. The software code and data 320 may be executed by the processor 316 to perform and/or control operations described herein with respect to the outdoor luminaire 300 and the outdoor luminaires of the system 100 that may each be an instance of the outdoor luminaire 300.

In some example embodiments, the outdoor luminaire 300 may include a GPS unit 304. For example, the GPS unit 304 may provide the controller 302 with location information indicating the location of the outdoor luminaire 300. For example, the location information may be used by the controller 302 or by another component of the outdoor luminaire 300 to determine locations, distances, etc. of objects, such as vehicles, relative to the outdoor luminaire 300. For example, the controller 302 may use radar data along with the location information from the GPS unit 304 to determine the location or relative distance of the vehicle 202 in the street 110.

To illustrate, the controller 302 may determine when a vehicle is at a particular location such as in front of the outdoor luminaire 300 based on the radar data and the location information of the outdoor luminaire 300 from the GPS unit 304. The GPS unit 304 may also provide highly accurate time information. For example, the time of reception of a sound, such as the sounds 204, 208, by the outdoor luminaire 300 may be determined from time information provided by the GPS unit 304. To illustrate, the time of reception (e.g., a timestamp) of a sound when a vehicle is at a particular location, such as at the virtual marker 210 or the virtual marker 212 shown in FIG. 2, may be obtained from the GPS unit.

As another example, the time of reception of a sound having a sound level (e.g., amplitude level) that is at or above a threshold level may be obtained from the GPS unit 304. As another example, time of reception of a sound when the sound is first detected by the outdoor luminaire 300 may be obtained from the GPS unit 304. In general, sound reception time information may be stored, for example, in the memory device 318 or another storage medium in association with a sound received by the outdoor luminaire 300 that may be stored as sound data.

In some example embodiments, the outdoor luminaire 300 may include a microphone unit 306 that may include one or more microphones (e.g., an array of microphones) that can capture/receive sounds. For example, the microphone unit 306 may receive/capture sounds caused by or resulting from a vehicle driving on a street. To illustrate, a sound received by the microphone unit 306 may include engine sound, a sound made by tires moving on a road, vehicle honking sound within the sound sensing range of the microphone unit 306. In general, sounds generated by a large vehicle (e.g., three-plus axle vehicle) are louder (i.e., a higher amplitude) than sounds generated by smaller vehicles.

The controller 302 may process information from the microphone unit 306, for example, to perform operations such as determining whether the level of a sound received by the microphone unit 306 equals or exceeds a threshold sound level and to record/store in the memory device 318 the received sound as sound data along with sound reception time information from the GPS unit. For example, the controller 302 may store the sound as sound data in the memory device 318 if the level of the received sound equals or exceeds threshold sound level. The controller 302 may also send the sound data, for example, to the server 138 of the system 100 using the communication interface unit 314.

In some example embodiments, the outdoor luminaire 300 may include a radar unit 308 that can transmit and receive radar signals that can be used to detect vehicles that are within the radar detection range of the radar unit 308. For example, the radar unit 308 may detect vehicles and/or perform other operations based on radar signals transmitted and received by the radar unit 308. Alternatively or in addition, the controller 302 may process information from the radar unit 308 to detect vehicles and/or perform other operations. With respect to vehicles that are within the radar detection range, the radar unit 308 that can transmit and receive radar signals that can be used to determine speeds of vehicles, relative locations of detected vehicles (e.g., relative to the location of the outdoor luminaire 300), and vehicle movement directions, and to identify types of vehicles. For example, reflected radar signal amplitude and/or duration may be used to identify a type of a vehicle as belonging to a category from among two or more categories of vehicles such as a small car (e.g., a sedan or a small or mid-size sport utility vehicle (SUV)), a small truck (e.g., pick-up truck), a mid-size truck, a heavy truck (e.g., an 18-wheeler truck), a bus, or a trailer as can be readily understood by those of ordinary skill in the art with the benefit of this disclosure.

In some example embodiments, the outdoor luminaire 300 may include a vibration sensor 310 to measure vibrations of the outdoor luminaire 300. To illustrate, the outdoor luminaire 300 may be located on a side of the street 110, and the vibration sensor 310 may measure vibrations of the outdoor luminaire 300 caused by a vehicle moving in a vibration-sensing range of the vibration sensor 310. For example, the controller 302 may process vibration data from the vibration sensor 310 to determine when a vehicle that is moving in a street is right in front of the outdoor luminaire 300. As another example, the controller 302 may process vibration data from the vibration sensor 310 to determine whether multiple vehicles are moving in a street in the vicinity of the outdoor luminaire 300. To illustrate, the controller 302 may decide not to store/record sound received by the microphone unit 306 if the controller 302 determines that multiple vehicles are within the vicinity of the outdoor luminaire 300. The controller 302 may also determine from the vibration data whether a vehicle that caused the detected vibration is a relatively small vehicle (e.g., a sedan) or a relatively large vehicle (e.g., a three-plus axle vehicle). In some cases, the controller 302 may transmit the vibration data, for example, to the server 138 using the communication interface unit 314.

In some example embodiments, the outdoor luminaire 300 may include a light module 312 that provides a light. For example, the outdoor luminaire 300 may be a streetlight that is attached to a pole. The controller 302 may control the operation of the light module 312 that may, for example, include one or more light sources such as light emitting diode light sources.

In some example embodiments, the outdoor luminaire 300 may include the communication interface unit 314. The communication interface unit 314 may transmit and receive signals complaint with one or more wireless communication standards and/or wired communication protocol. For example, the communication interface unit 314 may transmit and receive Bluetooth Low Energy (BLE) signals, Wi-Fi signals, other wireless signals, and/or wireline signal such as Ethernet signals. The controller 302 may use the communication interface unit 314 to transmit information, for example, to other outdoor luminaires of the system 100, to the server 138, and/or other destinations. The controller 302 may also receive information through the communication interface unit 314, for example, from other outdoor luminaires and from the server 138.

In some example embodiments, the outdoor luminaire 300 may include one or more other devices 324. For example, the one or more other devices 324 may include an RF sensor for RF sensing. Alternatively or in addition, the one or more other devices 324 may include other sensors and measurement devices such as an anemometer. As described above, the outdoor luminaire 300 of FIG. 3 may correspond to each outdoor luminaire of the system 100 including the outdoor luminaires 102-108 and 112-118.

In some example embodiments, the outdoor luminaire 300 may include a driver that may receive AC power, for example, from a municipality power line, and provide DC power to the components of the outdoor luminaire 300 as can be readily understood by those of ordinary skill in the art with the benefit of this disclosure. In some alternative embodiments, the outdoor luminaire 300 may include more or fewer components than shown in FIG. 3 without departing from the scope of this disclosure. In some alternative embodiments, some of the components of the outdoor luminaire 300 may be integrated into a single component without departing from the scope of this disclosure. In some alternative embodiments, the outdoor luminaire 300 may include multiple processors, including some processors that may be inside some of the components of the outdoor luminaire 300, that perform different functions and may generally be referred to herein, together or individually, as a processor without departing from the scope of this disclosure.

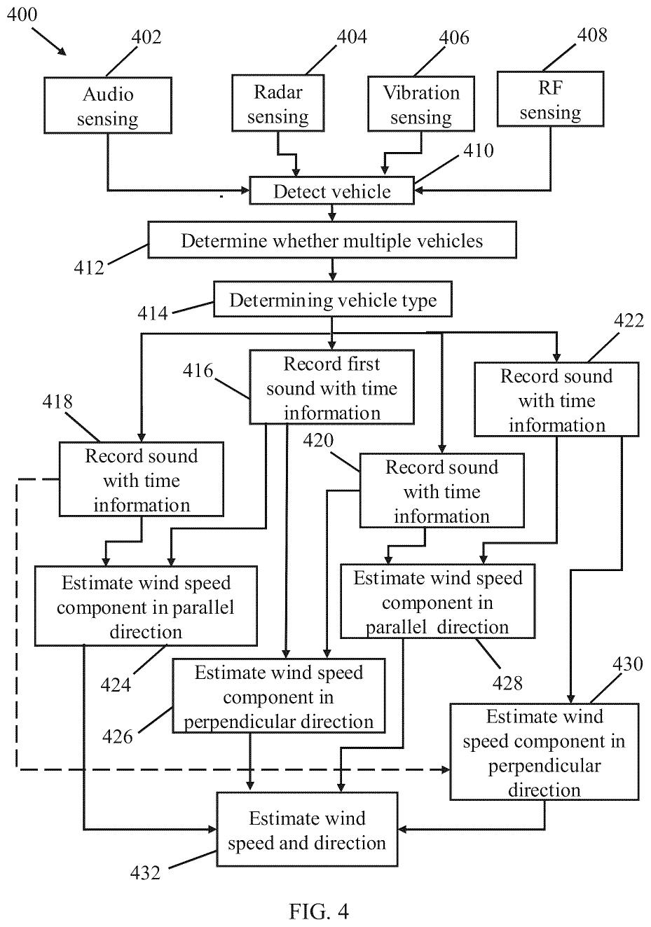

FIG. 4 illustrates a method 400 of operations of the outdoor luminaire system 100 of FIGS. 1 and 2 to estimate wind speed and direction according to an example embodiment. Referring to FIGS. 1-4, in some example embodiments, at step 402, the method 400 includes audio sensing by an outdoor luminaire. To illustrate, a microphone unit of each outdoor luminaire of the outdoor luminaires of the system 100 may receive a sound generated by a vehicle. The received sound may be used to detect one or more vehicles in the vicinity of the particular outdoor luminaire, to determine the type of vehicle (e.g., a sedan or a three-plus axle vehicle), to determine whether more than one vehicle are in the vicinity of the particular outdoor luminaire, and to determine when the vehicle is, for example, directly in front of the particular outdoor luminaire. For example, the outdoor luminaires 102, 106, 112 may each receive the sound 204 generated by the vehicle 202. As another example, the outdoor luminaires 106, 112, 116 may each receive the sound 208 generated by the vehicle 206.

In some example embodiments, alternatively or in addition to step 402, at step 404, the method 400 may include radar sensing by an outdoor luminaire. To illustrate, a radar unit of each outdoor luminaire of the outdoor luminaires of the system 100 may transmit and receive radar signals that can be used to detect one or more vehicles, to determine the type of vehicle (e.g., a sedan or a three-plus axle vehicle), to determine whether more than one vehicle are in the vicinity of the particular outdoor luminaire, and to determine the location of the vehicle relative to the particular outdoor luminaire such as when a vehicle is directly in front of the particular outdoor luminaire. For example, the outdoor luminaires 102, 106, 112 may each transmit and receive radar signals that can be used to detect the vehicle 202, determine the type of the vehicle 202, whether other vehicles are moving in the lane 122 along with the vehicle 202, etc. As another example, the outdoor luminaires 106, 112, 116 may each transmit and receive radar signals that can be used to detect the vehicle 206, determine the type of the vehicle 206, whether other vehicles are moving in the lane 124 along with the vehicle 206, etc.

In some example embodiments, alternatively or in addition to steps 402 and 404, at step 406, the method 400 may include vibration sensing by an outdoor luminaire. To illustrate, a vibration sensor of each outdoor luminaire of the outdoor luminaires of the system 100 may measure the vibration of the particular outdoor luminaire cause by one or more vehicles. The measured vibration may be used to detect one or more vehicles in the vicinity of the particular outdoor luminaire, to determine the type of vehicle (e.g., a sedan or a three-plus axle vehicle), to determine whether more than one vehicle are in the vicinity of the particular outdoor luminaire, and to determine when the vehicle is, for example, directly in front of the particular outdoor luminaire. For example, the outdoor luminaires 102, 106, 112, 116 may each measure vibrations caused by one or more vehicles moving on the street 110, etc.

In some example embodiments, alternatively or in addition to steps 402,404, and 406, at step 408, the method 400 may include RF sensing by an outdoor luminaire. To illustrate, a RF sensor of each outdoor luminaire of the outdoor luminaires of the system 100 may transmit and receive RF signals that can be used to detect one or more vehicles, to determine the type of vehicle (e.g., a sedan or a three-plus axle vehicle), to determine whether more than one vehicle are in the vicinity of the particular outdoor luminaire, and to determine the location of the vehicle relative to the particular outdoor luminaire such as when a vehicle is directly in front of the particular outdoor luminaire. For example, the outdoor luminaires 102, 106, 112, 116 may each transmit and receive RF signals that can be used to detect the vehicles 202, 204, determine the types and locations of the vehicles 202, 204, etc.

In some example embodiments, at step 410, the method 400 includes detecting a vehicle by an outdoor luminaire. For example, the controller of each outdoor luminaire of the system 100 may detect a vehicle based on a sound, radar sensing data, vibration sensing data, and/or RF sensing data. For example, based on characteristics of sounds typically generated by vehicles (e.g., engine sounds, tire sounds, etc.), the controller of an outdoor luminaire may determine that a sound is generated by a vehicle. The controller of each outdoor luminaire of the system 100 may also determine whether a vehicle is a particular location, such as right in front of the particular outdoor luminaire, based on a sound, radar sensing data, vibration sensing data, and/or RF sensing data.

For example, the outdoor luminaire 102 may determine when the vehicle 202 is in front of the outdoor luminaire 102 such as at the virtual marker 210, and the time corresponding to the vehicle 202 being in front of the outdoor luminaire 102 may be obtained from the GPS unit of the outdoor luminaire 102. As another example, the outdoor luminaire 106 may determine when the vehicle 202 is in front of the outdoor luminaire 106, and the time corresponding to the vehicle 202 being in front of the outdoor luminaire 106 may be obtained from the GPS unit of the outdoor luminaire 106. As another example, the outdoor luminaire 116 may determine when the vehicle 206 is in front of the outdoor luminaire 116 such as at the virtual marker 212, and the time corresponding to the vehicle 206 being in front of the outdoor luminaire 116 may be obtained from the GPS unit of the outdoor luminaire 116.

In some example embodiments, at step 412, the method 400 includes determining, by an outdoor luminaire, whether more than one vehicle are in the vicinity of the outdoor luminaire, for example, using sound, radar sensing data, vibration data, and/or RF sensing data. Because using a sound, such as the sound 204, that has minimal or no noise interference, including interference from sounds made by other vehicles, can result in more accurate estimates of wind speed and direction, each outdoor luminaire of the system 100 may determine whether more than one vehicle are in the vicinity of the particular outdoor luminaire. For example, if the outdoor luminaire 102 detects two or more vehicles while receiving the sound 204, the outdoor luminaire 102 may ignore (e.g., not store or use) the sound 204, where the sound 204 and related information, such a reception time, are not used to estimate wind speed and direction.

If no vehicle other than the vehicle 202 is detected by the outdoor luminaire 102, the outdoor luminaire 102 may store the sound 204 as sound data along with related information such as times of reception including a time of reception of the sound 204 when the vehicle 202 is, for example, in front of the outdoor luminaire 102. As another example, if the outdoor luminaire 116 detects two or more vehicles while receiving the sound 208, the outdoor luminaire 116 may ignore the sound 208. If no vehicle other than the vehicle 206 is detected by the outdoor luminaire 116, the outdoor luminaire 116 may store the sound 208 as sound data along with related information such as times of reception including a time of reception of the sound 208 when the vehicle 206 is, for example, in front of the outdoor luminaire 116.

In some example embodiments, at step 414, the method 400 includes determining, by an outdoor luminaire, the type of the detected vehicle. For example, the controller of the outdoor luminaire 102 may determine whether the vehicle 202 is a sedan or a three-plus axle vehicle. Because a relatively larger vehicle generally produces a louder sound than a relatively smaller vehicle, an outdoor luminaire may store and/or use a sound for estimating wind speed and direction if the outdoor luminaire determines that the vehicle is a three-plus vehicle. To be clear, two or more of steps 410, 412, 414 may be performed as a single step as can be readily understood by those of ordinary skill in the art with the benefit of this disclosure.

In some example embodiments, steps 402-414 may be performed by outdoor luminaires selected for use in estimating wind speed and direction in a particular area. For example, the outdoor luminaires 102, 106, 112, 116 may each perform one or more of steps 402-414. At step 416, one of the outdoor luminaires 102, 106, 112, 116 may store a sound received by the microphone unit of the particular outdoor luminaire as sound data along with reception time information from the GPS unit of the outdoor luminaire. For example, the outdoor luminaire 102 may store the sound 204 if the level (e.g., amplitude) of the sound 204 as received by the outdoor luminaire 102 equals or exceeds a threshold level. That is, the outdoor luminaire 102 may not store or otherwise use the sound 204 for wind speed and direction estimation if the level of the sound 204 equals or is below the threshold level.

In some cases, the outdoor luminaire 102 may store and the sound 204 and the associated reception time information if the outdoor luminaire 102 determines that the vehicle 202 is in the vicinity of the outdoor luminaire 102 and that no other vehicles is in the vicinity of the outdoor luminaire 102 to produce a sound that can interfere with the sound 204. For example, the outdoor luminaire 102 may not store the sound 204 if the outdoor luminaire 102 detects multiple vehicles in the vicinity of the vehicle such that a sound received by the outdoor luminaire 102 may include sounds produced by other vehicles. In some cases, the outdoor luminaire 102 may ignore the sound 204 if the type of the vehicle 202 as detected at step 414 is smaller than a typical three-axle vehicle. Alternatively, the outdoor luminaire 102 may store and/or use the sound 204 regardless of the type of the vehicle 202.

In some example embodiments, at step 418, the method 400 includes storing/recording, by another one of the outdoor luminaires 102, 106, 112, 116, a sound received by the microphone unit of the particular outdoor luminaire as sound data along with reception time information (i.e., times of reception of a sound) from the GPS unit of the outdoor luminaire. For example, the outdoor luminaire 106 may store the sound 204 and the associated reception time information in the manner described with respect to the outdoor luminaire 102. To be clear, the outdoor luminaire 106 may start recording/storing the sound 204 along with the associated reception time information before the vehicle 202 traveling in the lane 122 passes by the outdoor luminaire 102. As another example, the outdoor luminaire 106 may store the sound 208 along with the associated reception time information in the manner described with respect to the outdoor luminaire 102. The outdoor luminaire 106 may start recording/storing the sound 208 along with the associated reception time information before the vehicle 206 traveling in the lane 124 passes by the outdoor luminaire 116.

In some example embodiments, at step 420, the method 400 includes storing/recording, by another one of the outdoor luminaires 102, 106, 112, 116, a sound received by the microphone unit of the particular outdoor luminaire as sound data along with reception time information from the GPS unit of the outdoor luminaire. For example, the outdoor luminaire 112 may store the sound 204 along with the associated reception time information in the manner described with respect to the outdoor luminaire 102. To be clear, the outdoor luminaire 112 may start recording/storing the sound 204 along with the associated reception time information before the vehicle 202 traveling in the lane 122 passes by the outdoor luminaire 102. As another example, the outdoor luminaire 112 may store the sound 208 along with reception time information in the manner described with respect to the outdoor luminaire 102. The outdoor luminaire 112 may start recording/storing the sound 208 along with the associated reception time information before the vehicle 206 traveling in the lane 124 passes by the outdoor luminaire 116.

In some example embodiments, at step 422, the method 400 includes storing/recording, by another one of the outdoor luminaires 102, 106, 112, 116, a sound received by the microphone unit of the particular outdoor luminaire as sound data along with reception time information (i.e., times of reception of a sound) from the GPS unit of the outdoor luminaire. For example, the outdoor luminaire 116 may store the sound 208 generated by the vehicle 206 and the associated reception time information in the manner described with respect to the outdoor luminaire 102.

In some example embodiments, at step 424, the method 400 includes estimating a component of wind in a direction parallel to a street where the two outdoor luminaires that executed steps 416, 418 are located, which is also parallel to a virtual line connecting the two outdoor luminaires. For example, the outdoor luminaire 102 may execute some or all of the steps 402-416 with respect to the sound 204, and the outdoor luminaire 106 may execute some or all of the steps 402-414 and 418 with respect to the sound 204. The server 138 of the system 100 may receive sound data and reception time information from the outdoor luminaires 102, 106 with respect to the sound 204 and may execute Equation (1) to estimate the component of the speed of the wind 140 in a direction parallel to the street 110 and to the virtual line 130. The server 138 may also determine the particular direction of the component of the wind 140 as described above, for example, based on the polarity of the component of the speed of the wind 140. For example, the server 138 may determine whether the direction of the component of the speed of the wind 140 is from the outdoor luminaire 102 toward the outdoor luminaire 106 or from the outdoor luminaire 106 toward the outdoor luminaire 102.

In some example embodiments, at step 426, the method 400 includes estimating a component of wind in a direction perpendicular to the street where the two outdoor luminaires that executed steps 416, 420 are located, which is also parallel to a virtual line connecting the two outdoor luminaires. For example, the outdoor luminaire 102 may execute some or all of the steps 402-416 with respect to the sound 204, and the outdoor luminaire 112 may execute some or all of the steps 402-414 and 420 with respect to the sound 204. The server 138 of the system 100 may receive sound data and reception time information from the outdoor luminaires 102, 112 with respect to the sound 204 and may execute Equation (1) to estimate the component of the speed of the wind 140 in a direction perpendicular to the street 110 and parallel to the virtual line 132. The server 138 may also determine the particular direction of the component of the wind 140 as described above, for example, based on the polarity of the component of the speed of the wind 140. For example, the server 138 may determine whether the direction of the component of the speed of the wind 140 is from the outdoor luminaire 102 toward the outdoor luminaire 112 or from the outdoor luminaire 112 toward the outdoor luminaire 102.

In some example embodiments, at step 428, the method 400 includes estimating a component of wind in a direction parallel to a street where the two outdoor luminaires that executed steps 420, 422 are located, which is also parallel to a virtual line connecting the two outdoor luminaires. For example, the outdoor luminaire 116 may execute some or all of the steps 402-414 and 422 with respect to the sound 208, and the outdoor luminaire 112 may execute some or all of the steps 402-414 and 420 with respect to the sound 208. The server 138 of the system 100 may receive sound data and reception time information from the outdoor luminaires 112, 116 with respect to the sound 208 and may execute Equation (1) to estimate the component of the speed of the wind 140 in a direction parallel to the street 110 and to the virtual line 134. The server 138 may also determine the particular direction of the component of the wind 140 as described above, for example, based on the polarity of the component of the speed of the wind 140. For example, the server 138 may determine whether the direction of the component of the speed of the wind 140 is from the outdoor luminaire 116 toward the outdoor luminaire 112 or from the outdoor luminaire 112 toward the outdoor luminaire 116.

In some example embodiments, at step 430, the method 400 includes estimating a component of wind in a direction perpendicular to the street where the two outdoor luminaires that executed steps 418, 422 are located, which is also parallel to a virtual line connecting the two outdoor luminaires. For example, the outdoor luminaire 106 may execute some or all of the steps 402-414 and 418 with respect to the sound 208, and outdoor luminaire 116 may execute some or all of the steps 402-414 and 422 with respect to the sound 208. The server 138 of the system 100 may receive sound data and reception time information from the outdoor luminaires 106, 116 with respect to the sound 208 and may execute Equation (1) to estimate the component of the speed of the wind 140 in a direction perpendicular to the street 110 and parallel to the virtual line 136. The server 138 may also determine the particular direction of the component of the wind 140 as described above, for example, based on the polarity of the component of the speed of the wind 140. For example, the server 138 may determine whether the direction of the component of the speed of the wind 140 is from the outdoor luminaire 116 toward the outdoor luminaire 106 or from the outdoor luminaire 106 toward the outdoor luminaire 116.

In some example embodiments, at step 432, the method 400 includes estimating the speed and direction of wind, such as the wind 140, based on the components estimated at steps 424 and 426. For example, a vector addition of the components in the direction parallel to the street 110 and in the direction perpendicular to the street 110 as estimated at steps 424, 426 may be performed to estimate the speed and direction of the wind 140.

In some example embodiments, at step 432, the method 400 includes estimating the speed and direction of wind, such as the wind 140, based on the components estimated at steps 428 and 430. For example, a vector addition of the components in the direction parallel to the street 110 and in the direction perpendicular to the street 110 as estimated at steps 428, 430 may be performed to estimate the speed and direction of the wind 140.

In some example embodiments, the server 138 may determine whether the component of the speed of the wind 140 estimated based on the sound 204 at step 424 matches (e.g., within five percent of) the component of the speed of the wind 140 estimated based on the sound 208 at step 428. The server 138 may also determine whether the component of the speed of the wind 140 estimated based on the sound 204 at step 426 matches (e.g., within five percent of) the component of the speed of the wind 140 estimated based on the sound 208 at step 430. Alternatively or in addition, the server 138 may determine whether the speed of the wind 140 estimated at step 432 based on the estimated components of the speed of the wind 140 at steps 424, 426 matches (e.g., within five percent of) the speed of the wind 140 estimated at step 432 based on the estimated components of the speed of the wind 140 at steps 428, 430.

In some example embodiments, each outdoor luminaire of the outdoor luminaires selected for use in estimating wind speed and direction in a particular area may perform each step of the steps 402-414. Alternatively, one or more of the selected outdoor luminaires may not perform one or more of the steps 402-414. For example, a selected outdoor luminaire may perform steps 402, 410, 412 but may not perform steps 404-408, 414. As another example, a selected outdoor luminaire may perform steps 402, 410, 412, 414 but may not perform steps 404-408. As yet another example, a selected outdoor luminaire may perform steps 402, 410 followed by, for example, step 416. In some case, the server 138 may perform analysis of the sound data and reception time information from the outdoor luminaire and determine whether multiple vehicles were in the vicinity of the outdoor luminaire and/or determine the type of the vehicle that produced the sound received at step 402.

In some example embodiments, the server 138 may perform analysis of sound data and reception time information received from multiple selected outdoor luminaires to determine whether two vehicle travelling in opposite directions (e.g., the vehicles 202, 206) and that produced sounds (e.g., 204, 206) used in estimating wind speed and direction were concurrently at approximately the same relative location with respect to respective outdoor luminaires (e.g., 102, 116). To illustrate, the server 138 may perform analysis of sound data and reception time information received from the outdoor luminaires 102, 116 to determine whether the vehicle 202 was at or close to (e.g., less than five seconds from) the virtual marker 210 when the vehicle 206 was at the virtual marker 212 or vice versa. Because the consistency of estimates of the speed and direction of the wind 140 made using the sounds 204, 208 depends on the absence of abrupt changes in wind speed and direction, determining the locations of the vehicles 202 and 206 with respect to the outdoor luminaires 102 and 116, respectively, may be useful.

In some example embodiments, the server 138 may execute an artificial intelligence (AI) model to estimate the speed and direction of the wind 140. For example, an AI model may be trained based on sounds received by outdoor luminaires of the system 100 in areas where the wind speed and direction can readily be measured or otherwise reliably determined. The AI model may be trained using radar sensing data, vibration sensing data, and/or RF sensing data in addition to sounds and the reception time information from GPS units of the outdoor luminaires. Using the known wind speed and direction as ground truth and sound and times of reception of the sounds and possibly radar sensing data, vibration sensing data, and/or RF sensing data as inputs, the AI model can be trained. During operation, the outdoor luminaires of the system 100 may send sound data and reception time information as well as possibly radar sensing data, vibration sensing data, and/or RF sensing data to the server 138 that can execute the trained AI model to estimate the speed and direction of wind in the area where the outdoor luminaires that sent the information are located.

In some alternative embodiments, the method 400 may include operations other than those shown in FIG. 4 without departing from the scope of this disclosure. In some alternative embodiments, one or more operations of the method 400 may be omitted without departing from the scope of this disclosure. In some alternative embodiments, some of the operations of the method 400 may be performed in a different order than shown without departing from the scope of this disclosure. In some alternative embodiments, some of the operations of the method 400 may be combined into a single step or may be performed a common step without departing from the scope of this disclosure.

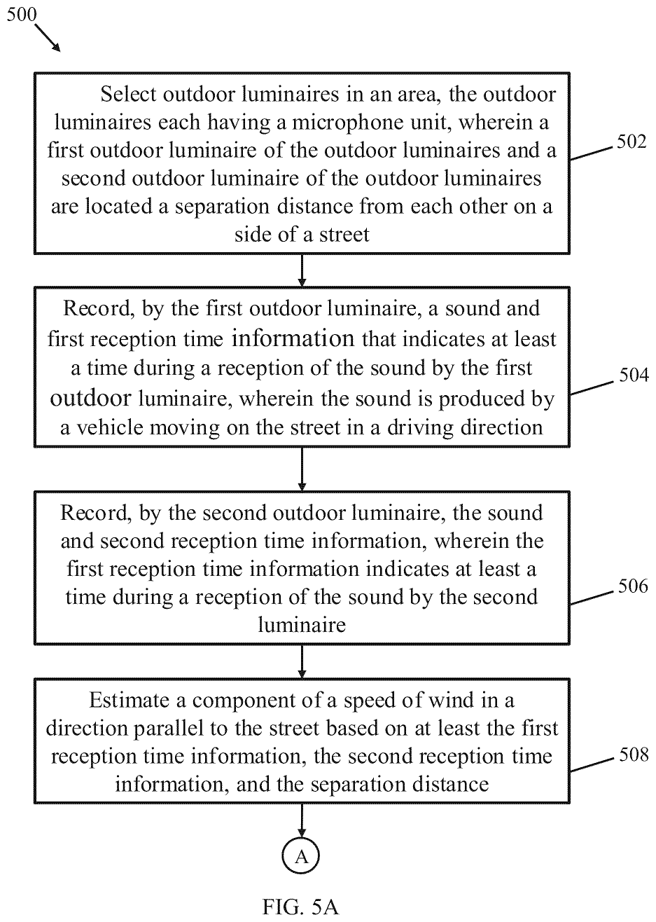

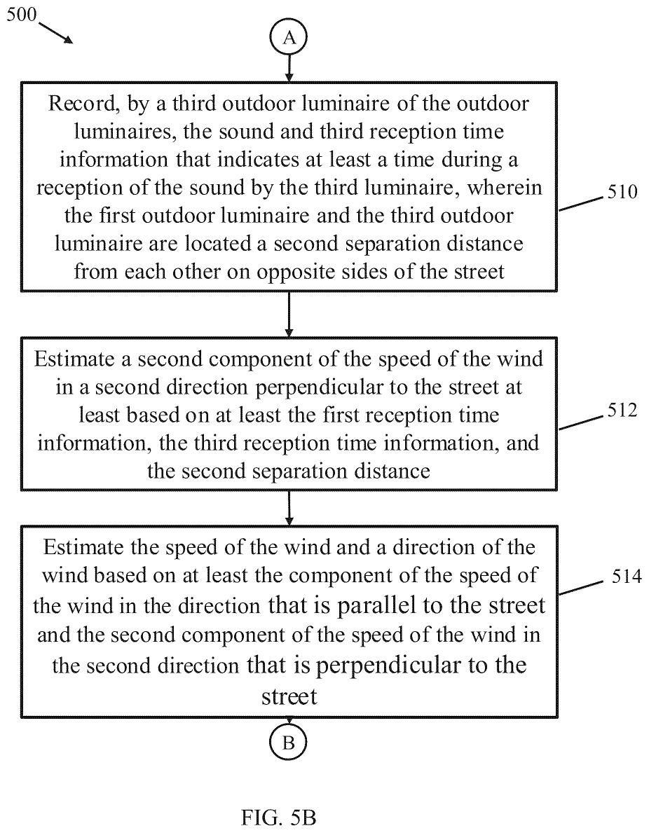

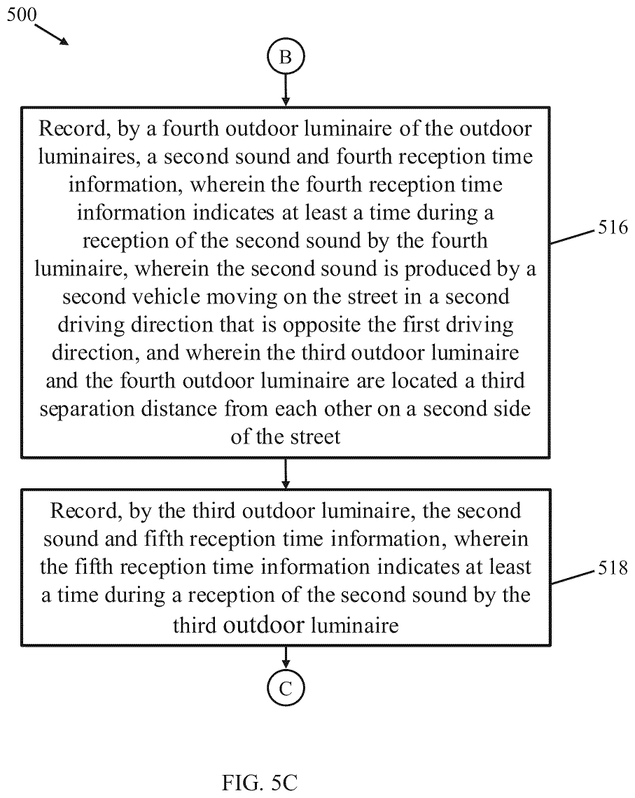

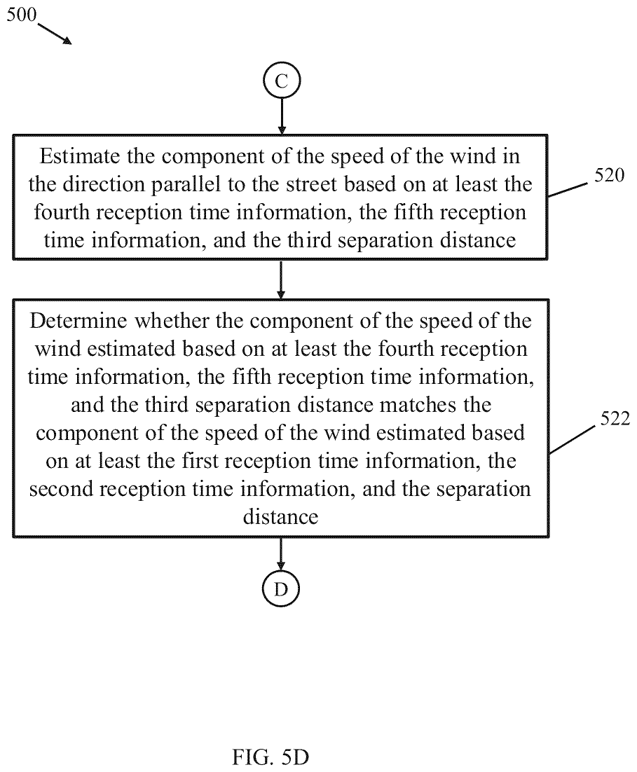

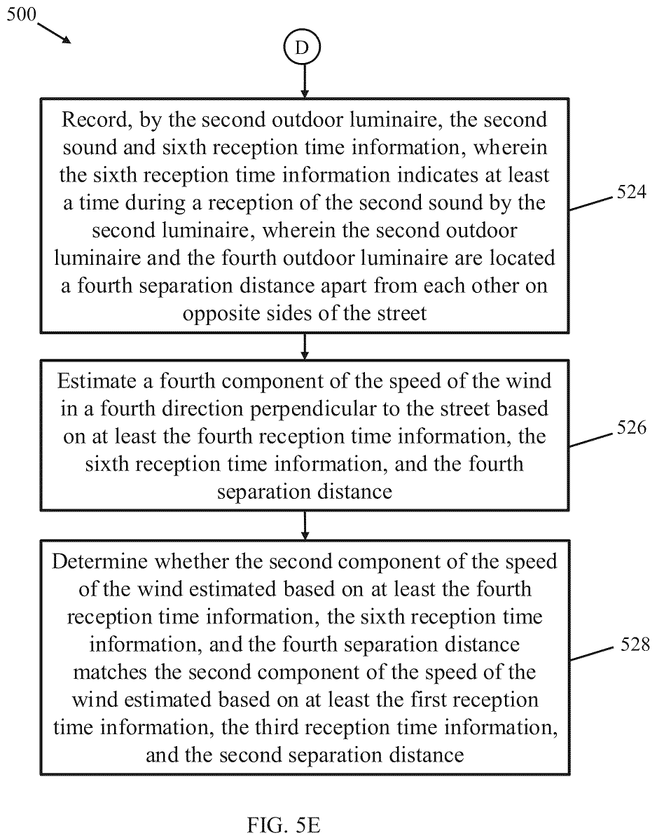

FIGS. 5A-5E illustrates a method 500 of estimating wind speed and direction by the outdoor luminaire system 100 of FIGS. 1 and 2 according to an example embodiment. Referring to FIGS. 1-5E, in some example embodiments, at step 502, the method 500 includes selecting outdoor luminaires in a geographic region 144, where the outdoor luminaires each include a microphone unit 306. A first outdoor luminaire of the outdoor luminaires and a second outdoor luminaire of the outdoor luminaires are located a separation distance D1 from each other on a side of a street 110. For example, the outdoor luminaires 102, 106 may be selected, where the outdoor luminaire 102 is the first outdoor luminaire and where the outdoor luminaire 106 is the second outdoor luminaire. The outdoor luminaire 102 may be located the separation distance D1 from the outdoor luminaire 106 on one side of the street 110. As described above, the outdoor luminaires 102, 106 may each be an instance of the outdoor luminaire 300 shown in FIG. 3 that includes the microphone unit 306.

At step 504, the method 500 may include recording by the first outdoor luminaire (e.g., the outdoor luminaire 102) a sound (e.g., the sound 204) and first reception time information (e.g., from a GPS unit of the outdoor luminaire 102) that indicates at least a time during a reception of the sound by the first outdoor luminaire. The sound is produced by a vehicle (e.g., the vehicle 202) moving on the street (e.g., the street 110) in a driving direction (e.g., arrow 126). For example, the first reception time information may indicate a time when the vehicle 202 is detected, for example, at the virtual marker 210 or at another location. Indeed, recording the sound (e.g., the sound 204) by the outdoor luminaire (e.g., the outdoor luminaire 102) may be performed in response to a detection of the vehicle by the outdoor luminaire. The first reception time information may also indicate the time when the level of the sound 204 equals or exceeds a threshold level.

For example, the outdoor luminaire 102 may record/store the sound 204 when the level of the sound 204 equals or exceeds the threshold level. The threshold level may be set at a value such that the sound 204 can be reliably received, for example, with minimal noise interference as can be readily understood by those of ordinary skill in the art with the benefit of this disclosure. The first reception time information may also indicate multiple times, for example, separated by an interval while the sound 204 equals or exceeds the threshold level.

At step 506, the method 500 may include recording, by the second outdoor luminaire 106 (e.g., the outdoor luminaire 106), the sound (e.g., the sound 204) and second reception time information that indicates at least a time (e.g., from a GPS unit of the outdoor luminaire 106) during a reception of the sound by the second luminaire. For example, the second reception time information may indicate a time that corresponds to the vehicle 202 being, for example, at the virtual marker 210. The second reception time information may also indicate the time when the level of the sound 204 as received by the second outdoor luminaire 106 (e.g., the outdoor luminaire 106), equals or exceeds a threshold level.

For example, the outdoor luminaire 106 may record/store the sound 204 when the level of the sound 204 equals or exceeds the threshold level. The second reception time information may also indicate multiple times, for example, separated by an interval while the sound 204 as received, for example, by the outdoor luminaire 106 equals or exceeds the threshold level. The threshold level used by the second outdoor luminaire (e.g., the outdoor luminaire 106) may be the same as or different from the threshold level used by the first outdoor luminaire (e.g., the outdoor luminaire 102).

At step 508, the method 500 may include estimating a component of a speed of wind 140 in a direction that is parallel to the street 110 based on at least the first reception time information, the second reception time information, and the separation distance D1 (e.g., the separation distance D1). For example, the server 138 may execute Equation (1) to estimate a component of the speed of the wind 140 in a direction parallel to the street 110. The server 138 may also estimate or otherwise determine the exact direction of the component of the speed of the wind 140. For example, the server 138 may determine whether the component of the speed of the wind 140 that is parallel to the street 110 is in a direction from the outdoor luminaire 102 toward the outdoor luminaire 106 or from the outdoor luminaire 106 toward the outdoor luminaire 102.

At step 510, the method 500 may include recording, by a third outdoor luminaire 112 (e.g., the outdoor luminaire 112) of the outdoor luminaires, the sound 204 (e.g., the sound 204) and third reception time information that indicates at least a time (e.g., from a GPS unit of the outdoor luminaire 112) during a reception of the sound by the third luminaire. For example, the third outdoor luminaire may be the outdoor luminaire 112 and may be one of the outdoor luminaires selected at step 502 of the method 500. The first outdoor luminaire (e.g., the outdoor luminaire 102) and the third outdoor luminaire (e.g., the outdoor luminaire 112) may be located a second separation distance (e.g., the separation distance D2) from each other on opposite sides of the street (e.g., the street 110) from each other. The third reception time information may indicate a time that corresponds to the vehicle 202 being, for example, at the virtual marker 210. The third reception time information may also indicate the time when the level of the sound 204 as received by the third outdoor luminaire (e.g., the outdoor luminaire 112) equals or exceeds a threshold level.

For example, the outdoor luminaire 112 may record/store the sound 204 when the level of the sound 204 as received by the outdoor luminaire 112 equals or exceeds the threshold level. The third reception time information may also indicate multiple times, for example, separated by an interval while the sound 204 as received by the third outdoor luminaire equals or exceeds the threshold level. The threshold level used by the third outdoor luminaire (e.g., the outdoor luminaire 112) may be the same as or different from the threshold level used by the first outdoor luminaire (e.g., the outdoor luminaire 102).

At step 512, the method 500 may include estimating a second component of the speed of the wind (140) in a second direction that is perpendicular to the street 110 based on at least the first reception time information, the third reception time information, and the second separation distance (e.g., the separation distance D2). For example, the server 138 may execute Equation (1) to estimate the second component of the speed of the wind 140 in a direction perpendicular to the street 110. The server 138 may also estimate or otherwise determine the exact direction of the second component of the speed of the wind 140. For example, the server 138 may determine whether the second component of the speed of the wind 140 that is perpendicular to the street 110 is in a direction from the outdoor luminaire 102 toward the outdoor luminaire 112 or from the outdoor luminaire 112 toward the outdoor luminaire 102.

At step 514, the method 500 may include estimating the speed of the wind 140 and a direction of the wind 140 based on at least the component of the speed of the wind in the direction that is parallel to the street 110 performed at step 508 and the second component of the speed of the wind in the second direction that is perpendicular to the street 110 performed at step 512. For example, the server 138 may perform a vector addition of the estimated components of the speed of the wind 140 to estimate the overall speed and direction of the wind 140. Estimating the speed of the wind and the direction of the wind at step 514 may depend on determining an absence of a vehicle other than the vehicle 202 in a detection range (e.g., based on radar, sound, vibration, RF) of the first outdoor luminaire 102. For example, the first outdoor luminaire (e.g., the outdoor luminaire 102) may not store the sound 204 if the first outdoor luminaire detects one or more vehicles other than the vehicle 202 moving in the lane 122. Alternatively or in addition, estimating the speed of the wind and the direction of the wind at step 514 may be performed if the vehicle (e.g., the vehicle 202) is a three or more axle vehicle.

At step 516, the method 500 may include recording, by a fourth outdoor luminaire 116 (e.g., the outdoor luminaire 116) of the outdoor luminaires, a second sound (e.g., the sound 208) and fourth reception time information (e.g., from a GPS unit of the outdoor luminaire 102) that indicates at least a time during a reception of the second sound by the fourth luminaire. For example, the fourth outdoor luminaire may be the outdoor luminaire 116 and may be one of the outdoor luminaires selected at step 502 of the method 500. The third outdoor luminaire (e.g., the outdoor luminaire 112) and the fourth outdoor luminaire (e.g., the outdoor luminaire 116) may be located a third separation distance (e.g., the separation distance D3) from each other on a second side of the street (e.g., the street 110) across from the first and second outdoor luminaires (e.g., the outdoor luminaires 102, 106).

The second sound (e.g., the sound 208) may be produced by a second vehicle (e.g., the vehicle 206) moving on the street (e.g., the street 110) in a second driving direction (e.g., arrow 128) that is opposite to the driving direction (e.g., arrow 126). For example, the fourth reception time information may indicate a time when the vehicle 206 is detected, for example, at the virtual marker 212 or at another location. The fourth reception time information may also indicate the time when the level of the sound 208 equals or exceeds a threshold level. For example, the outdoor luminaire 116 may record/store the sound 208 when the level of the sound 208 equals or exceeds the threshold level. The threshold level may be set at a value such that the sound 208 can be reliably received, for example, with minimal noise interference as can be readily understood by those of ordinary skill in the art with the benefit of this disclosure. The fourth reception time information may also indicate multiple times, for example, separated by an interval while the sound 208 equals or exceeds the threshold level.

At step 518, the method 500 may include recording, by the third outdoor luminaire (e.g., the outdoor luminaire 112), the second sound (e.g., the sound 208) and fifth reception time information (e.g., from a GPS unit of the outdoor luminaire 112) that indicates at least a time during a reception of the second sound by the third outdoor luminaire. For example, the fifth reception time information may indicate a time that corresponds to the vehicle 206 being, for example, at the virtual marker 212. The fifth reception time information may also indicate the time when the level of the sound 208 as received by the third outdoor luminaire 112 (e.g., the outdoor luminaire 112), equals or exceeds a threshold level.

For example, the outdoor luminaire 112 may record/store the sound 208 when the level of the sound 208 as received by the outdoor luminaire 112 equals or exceeds the threshold level. The second reception time information may also indicate multiple times, for example, separated by an interval while the sound 208 as received, for example, by the outdoor luminaire 112 equals or exceeds the threshold level. The threshold level used by the third outdoor luminaire (e.g., the outdoor luminaire 112) may be the same as or different from the threshold level used by the fourth outdoor luminaire (e.g., the outdoor luminaire 116).

At step 520, the method 500 may include estimating the component of the speed of the wind 140 in the direction that is parallel to the street based on at least the fourth reception time information, the fifth reception time information, and the third separation distance D3. For example, the server 138 may execute Equation (1) to estimate the component of the speed of the wind 140 in a direction parallel to the street 110 based on the fourth reception time information, the fifth reception time information, and the third separation distance D3. The server 138 may also estimate or otherwise determine the exact direction of the component of the speed of the wind 140. For example, the server 138 may determine whether the component of the speed of the wind 140 that is parallel to the street 110 is in a direction from the outdoor luminaire 102 toward the outdoor luminaire 106 or from the outdoor luminaire 106 toward the outdoor luminaire 102.

At step 522, the method 500 may include determining whether the component of the speed of the wind estimated at step 520 based on the fourth reception time information, the fifth reception time information, and the third separation distance (e.g., the separation distance D3) matches the component of the speed of the wind estimated at step 508 based on the first reception time information, the second reception time information, and the separation distance D1. For example, the two estimates may be considered as matching if the values are within, for example, five percent of each other. In some cases, whether the component of the speed of the wind estimated based on the fourth reception time information, the fifth reception time information, and the third separation distance D3 matches the component of the speed of the wind estimated based on the first reception time information, the second reception time information, and the separation distance D1 may be determined in response to the first vehicle 202 being at the first outdoor luminaire 102 while the second vehicle 206 is substantially concurrently at the fourth outdoor luminaire 116.

At step 524, the method 500 may include recording, by the second outdoor luminaire (e.g., the outdoor luminaire 106), the second sound (e.g., sound 208) and sixth reception time information (e.g., from a GPS unit of the outdoor luminaire 106) that indicates at least a time during a reception of the second sound by the second luminaire. The second outdoor luminaire (e.g., the outdoor luminaire 106) and the fourth outdoor luminaire (e.g., the outdoor luminaire 116) may be located a fourth separation distance (e.g., the separation distance D4) apart from each other on opposite sides of the street (e.g., the street 110). The sixth reception time information may indicate a time that corresponds to the vehicle 206 being, for example, at the virtual marker 212. The sixth reception time information may also indicate the time when the level of the sound 208 as received by the third outdoor luminaire (e.g., the outdoor luminaire 112) equals or exceeds a threshold level.

For example, the outdoor luminaire 112 may record/store the sound 208 when the level of the sound 208 as received by the outdoor luminaire 112 equals or exceeds the threshold level. The sixth reception time information may also indicate multiple times, for example, separated by an interval while the sound 208 as received by the third outdoor luminaire equals or exceeds the threshold level. The threshold level used by the third outdoor luminaire (e.g., the outdoor luminaire 112) may be the same as or different from the threshold level used by the fourth outdoor luminaire (e.g., the outdoor luminaire 116).

At step 526, the method 500 may include estimating the second component of the speed of the wind (e.g., the wind 140) in the second direction that is perpendicular to the street (e.g., the street 110) based on at least the fourth reception time information, the sixth reception time information, and the fourth separation distance (e.g., the separation distance D4). For example, the server 138 may execute Equation (1) to estimate the second component of the speed of the wind 140 in a direction perpendicular to the street 110. The server 138 may also estimate or otherwise determine the exact direction of the second component of the speed of the wind 140. For example, the server 138 may determine whether the second component of the speed of the wind 140 that is perpendicular to the street 110 is in a direction from the outdoor luminaire 116 toward the outdoor luminaire 112 or from the outdoor luminaire 112 toward the outdoor luminaire 116.

At step 528, the method 500 may include determining whether the second component of the speed of the wind estimated at step 512 based on the fourth reception time information, the sixth reception time information, and the fourth separation distance (e.g., the separation distance D4) matches the second component of the speed of the wind estimated at step 526 based on the first reception time information, the third reception time information, and the second separation distance (e.g., the separation distance D2). For example, the two estimates may be considered as matching if the values are within, for example, five percent of each other. In some cases, whether the second component of the speed of the wind estimated based on the based on the fourth reception time information, the sixth reception time information, and the fourth separation distance (e.g., the separation distance D4) matches the second component of the speed of the wind estimated based on the first reception time information, the third reception time information, and the second separation distance (e.g., the separation distance D2) may be determined in response to the first vehicle 202 being at the first outdoor luminaire 102 while the second vehicle 206 is substantially concurrently at the fourth outdoor luminaire 116.

By using sounds generated by vehicles and captured by microphone units of outdoor luminaires located throughout a region, wind speed and direction can be estimated on hyper-local level for many parts of the region. Such granular wind speed and direction information, which may be unavailable from another source, can be used for various purposes including analyzing air pollution, assessing wildfire risks, taking pre-emptive actions by power utility companies to mitigate wind related damage to power lines, making decision on outdoor activities, etc. In addition, such granular wind speed and direction information may be used to develop models such as air pollution models, wildfire risk models, powerline risk models, etc.

In some alternative embodiments, the method 500 may include steps other than shown and/or described without departing from the scope of this disclosure. In some alternative embodiments, some of the steps of the method 500 may be performed in a different order than shown without departing from the scope of this disclosure. In some alternative embodiments, some of the steps of the method 500 may be omitted without departing from the scope of this disclosure. In some alternative embodiments, the server 138 may execute an AI model to perform some of the steps of the method 500, such as steps 508, 512, 514, 520, 526 without departing from the scope of this disclosure.

Although particular embodiments have been described herein in detail, the descriptions are by way of example. The features of the example embodiments described herein are representative and, in alternative embodiments, certain features, elements, and/or steps may be added or omitted. Additionally, modifications to aspects of the example embodiments described herein may be made by those skilled in the art without departing from the scope of the following claims, the scope of which are to be accorded the broadest interpretation so as to encompass modifications and equivalent structures.

What is claimed is:

1. A method of estimating wind speed and wind direction, the method comprising:
selecting outdoor luminaires in a geographic region, the outdoor luminaires each having a microphone unit, wherein a first outdoor luminaire of the outdoor luminaires and a second outdoor luminaire of the outdoor luminaires are located a separation distance from each other on a side of a street;
recording, by the first outdoor luminaire, a sound and first reception time information that indicates at least a time during a reception of the sound by the first outdoor luminaire, wherein the sound is produced by a vehicle moving on the street in a driving direction;
recording, by the second outdoor luminaire, the sound and second reception time information that indicates at least a time during a reception of the sound by the second luminaire; and
estimating a component of a speed of wind in a direction that is parallel to the street based on at least the first reception time information, the second reception time information, and the separation distance.

2. The method of claim 1, further comprising:
recording, by a third outdoor luminaire of the outdoor luminaires, the sound and third reception time information that indicates at least a time during a reception of the sound by the third luminaire, wherein the first outdoor luminaire and the third outdoor luminaire are located a second separation distance from each other on opposite sides of the street; and
estimating a second component of the speed of the wind in a second direction that is perpendicular to the street based on at least the first reception time information, the third reception time information, and the second separation distance.

3. The method of claim 2, further comprising estimating the speed of the wind and a direction of the wind based on at least the component of the speed of the wind in the direction that is parallel to the street and the second component of the speed of the wind in the second direction that is perpendicular to the street.

4. The method of claim 3, wherein the time during the reception of the sound indicated by the first reception time information corresponds to the vehicle being at the first outdoor luminaire.

5. The method of claim 4, wherein the time during the reception of the sound by the first outdoor luminaire is obtained from a global positioning system unit of the first outdoor luminaire and wherein the time during the reception of the sound by the second luminaire time is obtained from a global positioning system unit of the second outdoor luminaire.

6. The method of claim 3, further comprising:
recording, by a fourth outdoor luminaire of the outdoor luminaires, a second sound and fourth reception time information, wherein the fourth reception time information indicates at least a time during a reception of the second sound by the fourth luminaire, wherein the second sound is produced by a second vehicle moving on the street in a second driving direction that is opposite to the driving direction, and wherein the third outdoor luminaire and the fourth outdoor luminaire are located a third separation distance from each other on a second side of the street;
recording, by the third outdoor luminaire, the second sound and fifth reception time information, wherein the fifth reception time information indicates at least a time during a reception of the second sound by the third outdoor luminaire; and
estimating the component of the speed of the wind in the direction that is parallel to the street based on at least the fourth reception time information, the fifth reception time information, and the third separation distance.

7. The method of claim 6, further comprising determining whether the component of the speed of the wind estimated based on at least the fourth reception time information, the fifth reception time information, and the third separation distance matches the component of the speed of the wind estimated based on at least the first reception time information, the second reception time information, and the separation distance.

8. The method of claim 7, wherein determining whether the component of the speed of the wind estimated based on at least the fourth reception time information, the fifth reception time information, and the third separation distance matches the component of the speed of the wind estimated based on at least the first reception time information, the second reception time information, and the separation distance is performed in response to the first vehicle being at the first outdoor luminaire while the second vehicle is substantially concurrently at the fourth outdoor luminaire.

9. The method of claim 6, further comprising:
recording, by the second outdoor luminaire, the second sound and sixth reception time information, wherein the sixth reception time information indicates at least a time during a reception of the second sound by the second luminaire and wherein the second outdoor luminaire and the fourth outdoor luminaire are located a fourth separation distance apart from each other on opposite sides of the street; and
estimating the second component of the speed of the wind in the second direction that is perpendicular to the street based on at least the fourth reception time information, the sixth reception time information, and the fourth separation distance.

10. The method of claim 9, further comprising determining whether the second component of the speed of the wind estimated based on at least the fourth reception time information, the sixth reception time information, and the fourth separation distance matches the second component of the speed of the wind estimated based on at least the first reception time information, the third reception time information, and the second separation distance.

11. The method of claim 3, wherein a first virtual line extending between the first outdoor luminaire and the second outdoor luminaire and a second virtual line extending between the first outdoor luminaire and the third outdoor luminaire form approximately a right angle.

12. The method of claim 3, wherein selecting the outdoor luminaires is performed based on at least one of weather information for the geographic region and an ambient noise level in a wind condition estimation area that is within the geographic region and wherein the outdoor luminaires are located in the wind condition estimation area.

13. The method of claim 3, wherein estimating the speed of the wind and the direction of the wind depends on determining an absence of a vehicle other than the vehicle in a detection range of the first outdoor luminaire.

14. The method of claim 3, wherein estimating the speed of the wind and the direction of the wind is performed if the vehicle is a three or more axle vehicle.

15. The method of claim 1, wherein recording the sound by the first outdoor luminaire is performed in response to a detection of the vehicle by the first outdoor luminaire.
